(19) United States
(12) Patent Application Publication
(10) Pub. No.: US 2003/0067190 A1
(43) Pub. Date: Apr. 10, 2003

(54) Structural member for a motor vehicle

(76) Inventors: Michael Dancasius, Wuppertal (DE); Marc D. Wild, Kuenzell (DE); Mohamed Sahul Hamid, Rochester, MI (US)

Correspondence Address: Charles K. Veenstra, Esq., Delphi Technologies, Inc., Legal Staff - M/C: 480-410-202, P.O. Box 5052, Troy, MI, 48007, US

(21) Appl. No.: 10/252,629

(22) Filed: Sep. 23, 2002

(30) Foreign Application Priority Data
Sep. 25, 2001 (GB) 0122993.9

(51) Int. Cl. B62D 25/00

(52) U.S. Cl. 296/187; 296/205

(57) ABSTRACT

A structural member (10) for a motor vehicle formed from metallic material, having a tubular configuration, and extending longitudinally, the structural member comprising a first substantially flat planar side (12) having first and second longitudinal edges (14,16); a second side (18) connected to the first side at or adjacent to the first longitudinal edge and at an angle to the first side; a third side (20) connected to the first side at or adjacent to the second longitudinal edge and at an angle to the first side; and a curved side (26) connecting the second and third members such that the cross-section of the structural member is substantially D-shaped. Provides a structural member which maintains a deformation force at a high level, and without collapsing.

### TECHNICAL FIELD

The present invention relates to a structural member for a motor vehicle.

### BACKGROUND OF THE INVENTION

In a motor vehicle, it is known to locate a structural member, in the form of a cross-car beam, in the cockpit area of the vehicle. The structural member extends across the vehicle below the dashboard. The steering column of the vehicle is secured to the structural member. During a collision, frontal crash energy is transmitted through the steering column to the structural member. Known designs of structural member have, in general, a circular cross-section which can resist the crash energy for a short time, but subsequently risk collapsing.

### SUMMARY OF THE INVENTION

It is an object of the present invention to provide an improvement to the structural member.

A structural member in accordance with the present invention for a motor vehicle is formed from metallic material, has a tubular configuration, and extends longitudinally, the structural member comprising a first substantially flat planar side having first and second longitudinal edges; a second side connected to the first side at or adjacent to the first longitudinal edge and at an angle to the first side; a third side connected to the first side at or adjacent to the second longitudinal edge and at an angle to the first side; and a curved side connecting the second and third members such that the cross-section of the structural member is substantially D-shaped.

Provides a structural member which maintains a deformation force at a high level without collapsing.

### BRIEF DESCRIPTION OF THE DRAWINGS

The present invention will now be described, by way of example, with reference to the accompanying drawings, in which:

FIG. 1 is a perspective view of a structural member in accordance with the present invention;

FIG. 2 is a cross-sectional view of the structural member of FIG. 1; and

FIGS. 3 to 7 are cross-sectional views of alternative embodiments of a structural member in accordance with the present invention.

### DESCRIPTION OF THE PREFERRED EMBODIMENT

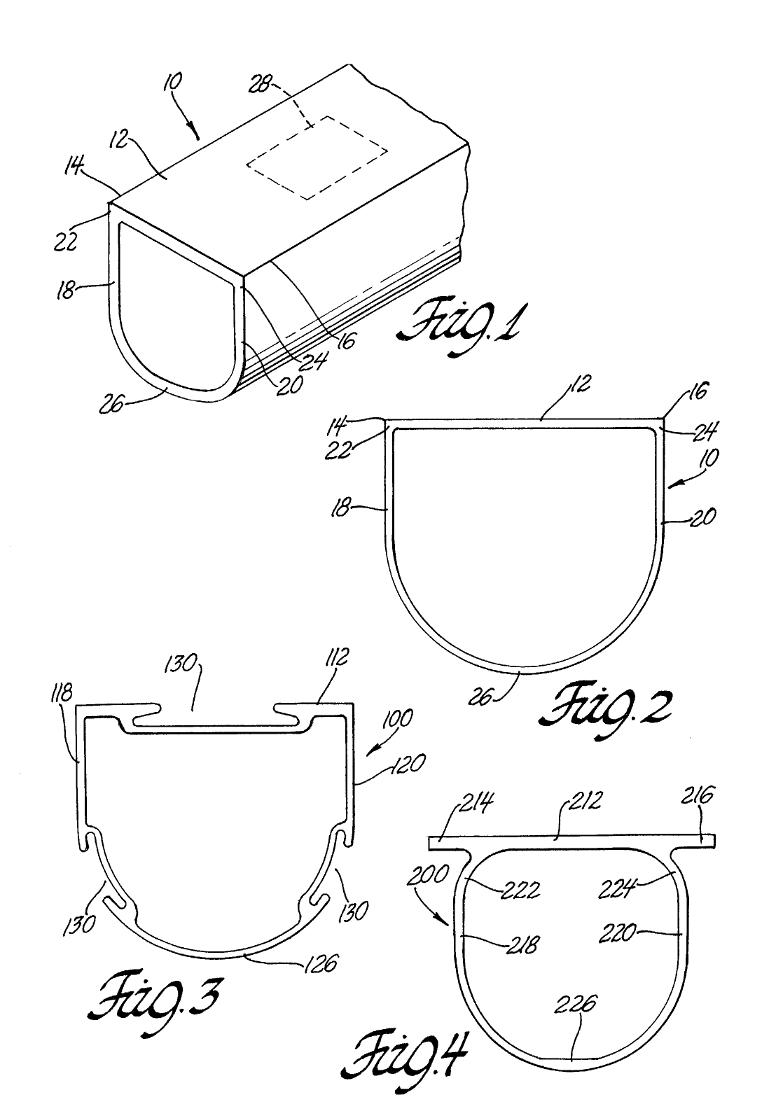

Referring to FIGS. 1 and 2, a structural member 10 in accordance with the present invention is straight, tubular, extends longitudinally, and is formed from metallic material (in this case, extruded aluminium or aluminium alloy). The structural member 10 has a first side 12 which is substantially flat and planar, and which has first and second longitudinal edges 14, 16, respectively. The structural member 10 also includes second and third sides 18, 20 which are substantially flat and planar, and which are integrally connected with the first and second edges 14,16 respectively, along their first respective first edges 22, 24 respectively. The angle between the first side 12 and second side 18 is substantially 90 degrees. The angle between the first side 12 and the third side 20 is substantially 90 degrees. The structural member 10 finally includes a curved side 26 which has a convex configuration and which is integrally connected with the second and third sides 18,20. The tubular structural member 10 therefore has a cross-sectional which is substantially D-shaped.

Embedded in the first side 12 at a predetermined position is a magnesium die-cast component 28 to provide support to the structural member where maximum deformation force may be required.

The structural member 10 is for use as a cross-beam in a motor vehicle and provides a flat surface 12 to which components can be secured. The magnesium component 28 is positioned where a steering column (not shown) is secured to the cross-beam. The structural member 10 provides a light weight cross-beam which can deform significantly, without collapsing, if the vehicle is subjected to a frontal impact. The structural member 10 maintains the deformation force at a high level by providing high energy absorption. This is achieved by the cross-sectional shape of the structural member 10, because the centre of gravity and the main inertia axis move relative to the compression area, thereby reducing the compression strain and stress. During a frontal vehicle impact, the compression strains and stresses are dissipated over a larger area than with previously known designs of structural member. In use, the flat surface is positioned in a motor vehicle to be substantially perpendicular to the expected direction of the compression force.

FIG. 3 shows a structural member 100 in accordance with the present invention which is a first modification of the structural member 10 of FIGS. 1 and 2. The structural member 100 has first, second, third and curved sides 112, 118, 120, 126 respectively which are substantially as described above. The first side 112 and the curved side 126 have integral longitudinally extending slots 130 formed therein for the mounting of vehicle components.

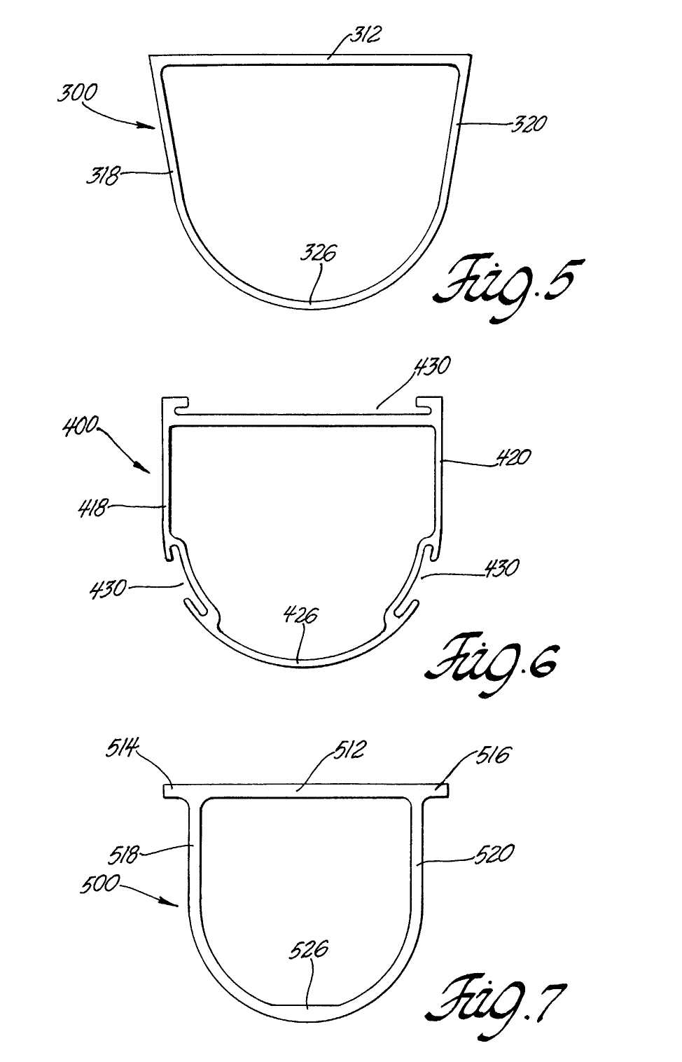

FIG. 4 shows a structural member 200 in accordance with the present invention which is a second modification of the structural member 10 of FIGS. 1 and 2. The structural member 200 has first, second, third and curved sides 212, 218, 220, 226 respectively which are substantially as described above. The second side 218 is curved adjacent its first edge 222 and is joined to the first side 212 adjacent the first edge 214 thereof. Similarly, the third side 220 is curved adjacent its first edge 224 and is joined to the first side 212 adjacent the second edge 216 thereof.

FIG. 5 shows a structural member 300 in accordance with the present invention which is a third modification of the structural member 10 of FIGS. 1 and 2. The structural member 300 has first, second, third and curved sides 312, 318, 320, 326 respectively which are substantially as described above. The second side 318 is connected to the first side 312 at an angle, preferably in the range 70 degrees to 90 degrees. Similarly, the third side 320 is connected to the first side 312 at an angle, preferably in the range 70 degrees to 90 degrees.

FIG. 6 shows a structural member 400 in accordance with the present invention which is a modification of the structural member 100 of FIG. 3. The structural member 400 has first, second, third and curved sides 412, 418, 420, 426 respectively which are substantially as described above. The first side 412 and the curved side 426 have integral longitudinally extending slots 430 formed therein for the mounting of vehicle components, in which the width of the slot in the first side is substantially equal to the width of the first side.

FIG. 7 shows a structural member 500 in accordance with the present invention which is a fourth modification of the structural member 10 of FIGS. 1 and 2. The structural member 500 has first, second, third and curved sides 512, 518, 520, 526 respectively which are substantially as described above. The second side 518 is joined to the first side 512 adjacent the first edge 514 thereof. Similarly, the third side 520 is joined to the first side 512 adjacent the second edge 516 thereof.

As mentioned above, the structural member of the present invention may be formed from extruded aluminium or aluminium alloy. Alternatively, the structural member of the present invention may be formed by rolling from sheet metallic material such as aluminium, aluminium alloy, or steel.

1. A structural member for a motor vehicle formed from metallic material, having a tubular configuration, and extending longitudinally, the structural member comprising a first substantially flat planar side having first and second longitudinal edges; a second side connected to the first side at or adjacent to the first longitudinal edge and at an angle to the first side; a third side connected to the first side at or adjacent to the second longitudinal edge and at an angle to the first side; and a curved side connecting the second and third sides such that the cross-section of the structural member is substantially D-shaped.

2. A structural member as claimed in claim 1, wherein the second and third sides are substantially flat and planar.

3. A structural member as claimed in claim 2, wherein the structural member is formed from aluminium or aluminium alloy.

4. A structural member as claimed in claim 3, wherein the structural member is formed by extrusion.

5. A structural member as claimed in claim 4, wherein a magnesium die-cast component is embedded in the structural member at a predetermined position.

6. A structural member as claimed in claim 3, wherein the structural member is formed by rolling from a sheet of aluminium or aluminium alloy.

7. A structural member as claimed in claim 2, wherein the structural member is formed from steel.

8. A structural member as claimed in claim 7, wherein the structural member is formed by rolling from a sheet of steel.

9. A structural member as claimed in claim 2 wherein the angle between the first side and the second side is substantially 90 degrees; and wherein the angle between the first side and the third side is substantially 90 degrees.

10. A structural member as claimed in claim 2 wherein the angle between the first side and the second side is between 70 and 90 degrees; and wherein the angle between the first side and the third side is between 70 and 90 degrees.

11. A structural member for a motor vehicle formed from metallic material, having a tubular configuration, and extending longitudinally, the structural member comprising a first substantially flat planar side having an integral longitudinally extending slot formed therein for mounting of vehicle components and first and second longitudinal edges; a second side connected to the first side at or adjacent to the first longitudinal edge and at an angle to the first side; a third side connected to the first side at or adjacent to the second longitudinal edge and at an angle to the first side; and a curved side connecting the second and third sides such that the cross-section of the structural member is substantially D-shaped.

12. A structural member as claimed in claim 11 wherein the slot is substantially equal to the width of the first side.

13. A structural member as claimed in claim 11 wherein the second and third sides each have an integral longitudinally extending slot formed therein for mounting of vehicle components.

14. A structural member as claimed in claim 12 wherein the second and third sides each have an integral longitudinally extending slot formed therein for mounting of vehicle components.

15. A structural member for a motor vehicle formed from metallic material, having a tubular configuration, and extending longitudinally, the structural member comprising a first substantially flat planar side having first and second longitudinal edges; a second generally planar side having a curved end portion connected to the first side at or adjacent to the first longitudinal edge; a third generally planar side having a curved end portion connected to the first side at or adjacent to the second longitudinal edge; and a curved side connecting the second and third sides such that the cross-section of the structural member is substantially D-shaped.
